(19) United States
(12) Patent Application Publication
(10) Pub. No.: US 2010/0072747 A1
(43) Pub. Date: Mar. 25, 2010

(54) TREE POLE COUPLER SYSTEM

(76) Inventor: DENNIS KRIZE, Trumbull, CT (US)

Correspondence Address: SARA CENTIONI KANOS;NEXSEN PRUET, LLC, P.O. DRAWER 10648, GREENVILLE, SC, 29603-0648, US

(21) Appl. No.: 12/234,935

(22) Filed: Sep. 22, 2008

(51) Int. Cl. F16L 21/08

(52) U.S. Cl. 285/330

(57) ABSTRACT

A coupler system for use in assembling artificial tree trunks or poles. In particular, the coupler system includes a first part having a cone-shaped end and carrying a wedge-shaped groove parallel to its axis, which is insertable into a second part that is formed as a pair of concentric cylinders. The inner of these cylinders receives the first part of the coupler system and includes a bulge parallel to its axis that aligns with the wedge-shaped groove of the first part when the two are fitted together. Preferably, the end of the first part opposite the cone-shaped end is dimensioned to fit into a first tubular segment that stands as a surrogate for a tree trunk. Additionally, the outer of the concentric cylinders is dimensioned to receive a second tubular segment.

### BACKGROUND OF THE INVENTION

The present invention relates to artificial tree systems, and, in particular, to coupler systems used in connection with artificial tree trunk segments.

The popularity of artificial trees is ever increasing. The use of artificial trees in decorating, especially during holidays, offers a convenient, yet still aesthetically pleasing alternative to natural trees. Live trees are often as expensive, or more so, than artificial trees. Furthermore, significant cleaning and maintenance is required for live trees, which require water and which shed materials such as leaves, needles or sap. Many types of natural trees used for holiday decorating also have a short life span and must be removed following the holiday and then replaced before the next holiday season.

By contrast, artificial trees require only a one-time purchase, and do not need watering or grooming to be maintained. Depending on the size and features of the artificial tree, such trees are commonly sold disassembled for ease of packaging and storage. Assembly of artificial trees typically requires the user to connect pole sections to form the trunk of the tree. Because the segments and couplers are typically made of steel and are therefore heavy, and prone to corrosion, they tend to become wedged together and difficult to separate. The more difficult the segments are to separate, the more likely that other common tree features, such as light strings, become damaged.

Accordingly, there exists a need for a simplified and effective coupler system for use in assembling artificial trees.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

According to its main features and briefly stated, the present invention is a coupler system for use in assembling artificial tree trunks or poles. In particular, the coupler system includes a first part having a cone-shaped end and carrying a wedge-shaped groove parallel to its major axis, which runs through the tip of the cone. The first part is insertable into a second part that is in the form of a pair of concentric cylinders joined at one end. The inner of the two cylinders receives the first part of the coupler system and includes a bulge parallel to its major axis alignable with the wedge-shaped groove of the first part when the two are being fitted together. Preferably, the end of the first part opposite the cone-shaped end is dimensioned to fit into one of a first tubular segments. The gap between the inner and the outer of the concentric cylinders is dimensioned to receive a second tubular segment.

In an exemplary embodiment, an artificial tree employing the coupler system of the present invention includes a top portion having an arrangement of artificial branches. The top portion includes first tubular segment, the lower end of which receives the first part of the coupler system. The artificial tree further includes a bottom portion having an arrangement of artificial branches. The bottom portion includes second tubular segment, the top end of which receives the second part of the coupler system of the present invention.

A feature of the present invention includes the use of a wedge-shaped groove parallel to its axis. The groove makes it easier to align the two parts when the first part is inserted into the second part.

The bulge is a second feature of the present invention as it aligns the two parts when the first part is being inserted into the second part.

Still another feature of the present invention is the use of a cone-shaped end on the first part which allows easier insertion of the first part into the second part.

Yet another feature of the present invention is the use of a first part and a second part made of plastic. The use of plastic rather than metal avoids corrosion of the parts. Accordingly, the shape and proper fitting of parts is maintained. More importantly, the parts are much easier to separate when they remain free of the negative effects of oxidation. Corroded tree segments and couplers of assembled trees must often be forced apart. Furthermore, as many artificial trees include the use of light strings, which are delicate in nature, damage to these light strings is minimized or avoided when the tree segments can be more easily separated.

Other features and advantages of the present invention will be apparent to those skilled in the art from a careful reading of the Detailed Disclosure of the Preferred Embodiment presented below and accompanied by the drawings.

### BRIEF DESCRIPTION OF THE DRAWINGS

In the drawings,

FIG. 1 is an exploded perspective view of a tree pole coupler system in use with an artificial tree according to a preferred embodiment of the present invention;

FIG. 2 is an exploded perspective view of the tree pole coupler system according to a preferred embodiment of the present invention;

FIG. 3 is a perspective view of a first part of a tree pole coupler system according to a preferred embodiment of the present invention;

FIG. 4 is a side view of a first part of a tree pole coupler system according to a preferred embodiment of the present invention;

FIG. 5 is an top view of a first part of a tree pole coupler system according to a preferred embodiment of the present invention;

FIG. 6 is a bottom view of a first part of a tree pole coupler system according to a preferred embodiment of the present invention;

FIG. 7 is a perspective view of a second part of a tree pole coupler system according to a preferred embodiment of the present invention;

FIG. 8 is a side view of a second part of a tree pole coupler system according to a preferred embodiment of the present invention;

FIG. 9 is a top view of a second part of a tree pole coupler system according to a preferred embodiment of the present invention;

FIG. 10 is a bottom view of a second part of a tree pole coupler system according to a preferred embodiment of the present invention;

FIG. 11 is an exploded, side cross-sectional view of a tree pole coupler system according to a preferred embodiment of the present invention;

FIG. 12 is an assembled, side cross-sectional view of tree pole coupler system according to a preferred embodiment of the present invention;

FIG. 13 is a bottom view of a tree pole coupler system according to a preferred embodiment of the present invention;

FIG. 14 is a bottom view of a tree pole coupler system according to a preferred embodiment of the present invention; and

FIG. 15 is a bottom view of a tree pole coupler system according to a preferred embodiment of the present invention.

### DETAILED DESCRIPTION OF THE PREFERRED EMBODIMENT

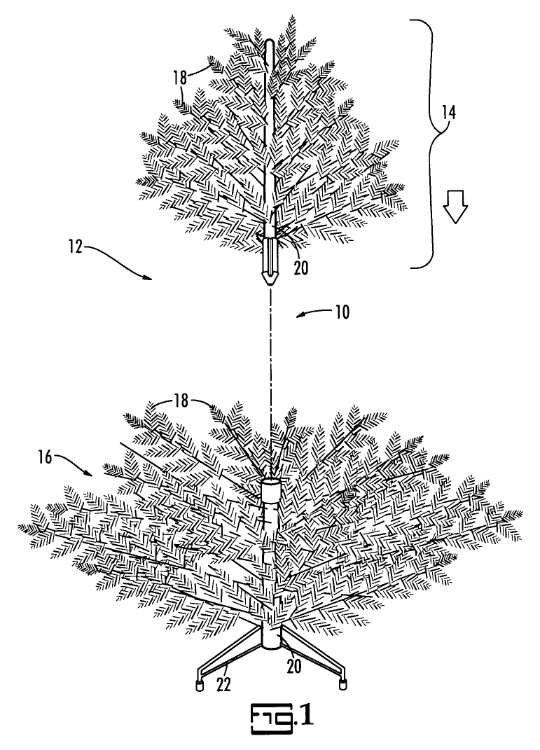

Referring now to the figures, FIG. 1 shows an exploded view of an artificial tree 12 having a top portion 14 and bottom portion 16 that are assembled and joined using a tree coupler system 10 according to the present invention. Top portion 14 and bottom portion 16 may be hollow cylinders that may be made of metal, and preferably made of steel and may receive synthetic branches that may simulate pine branches. The features of the artificial tree 12 are shown so as to place the coupler system 10 of the present invention into context. It is thus within the purview of the present invention to combine the coupler system 10 with artificial trees having any number of sections, as well as a variety of features and dimensions.

As shown, top and bottom portions 14, 16 of artificial tree 12 are adapted to be removably secured or joined together by coupler system 10 in a manner which allows a single longitudinal stem or trunk 20 to be formed by their interconnection. Both the top and bottom portions 14, 16 may include a plurality of branches 18 that are longer toward the base of the tree 12 and may be progressively shorter near the top of the tree 12 to give the artificial tree 12 a generally conical overall shape. The number, shape, size of, and materials used to form the branches 18 can be changed to accommodate the desired look of the tree 12. As further illustrated, the artificial tree 12 is maintained in a generally upright, vertical position by a stand 22. It may, of course, possible to use a variety of other stands or bases for the artificial tree 12.

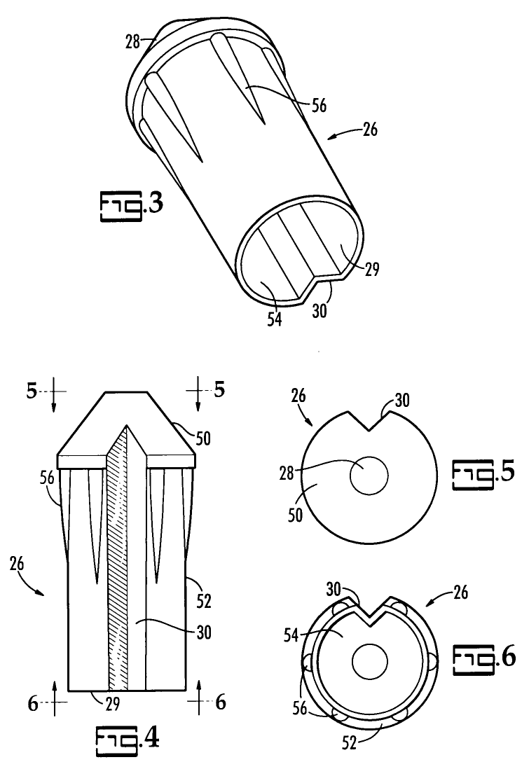

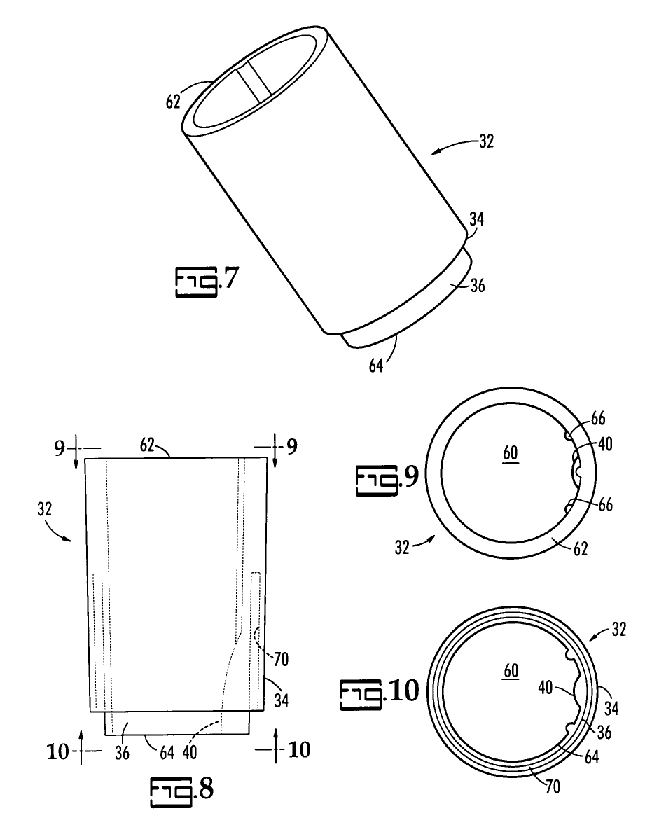

The particular features of the tree coupler system 10 used to connect the top and bottom portions 12, 14 of artificial tree 12 are shown in FIGS. 2-12. The coupler system 10 includes a first part 26 having a cone-shaped first end 28 and an opposing second end 29 and carrying a wedge-shaped groove 30 parallel to its axis. The first part 26 is telescopingly insertable into a second part 32 by a male-female member relationship. The second part 32 is formed as a pair of concentric cylinders, including an outer cylinder 34 and an inner cylinder 36 that are connected. The inner cylinder 36 is dimensioned to receive the first part 26 of the coupler system 10 and includes a bulge 40 parallel to its axis that aligns with the wedge-shaped groove 30 of the first part 26 to provide a key fit when the two are joined together.

Preferably, top and bottom portions 14, 16 of artificial 12 are connected to the tree coupler system 10 by a first and second tubular segment or pole 24, 25 respectively, shown in FIG. 2. First and second tubular segments 24, 25 can either be connected integrally or operatively to the top and bottom portions 14, 16 of the artificial tree 12, respectively. When tree trunk 20 is fully assembled, first and second parts 26, 32 of coupler system have a coaxial nesting relationship with first and second tubular segments 24, 25, respectively. Specifically, first part 26 is inserted into first tubular segment 24; and second part 26 receives second tubular segment 25, as will be described more fully below.

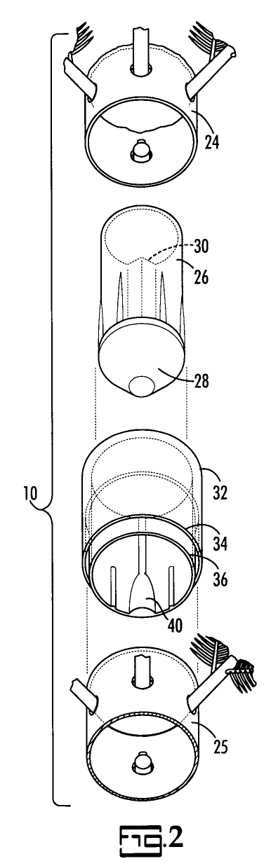

The first part 26 of the tree coupler system 10 is shown in greater detail in FIGS. 3-6. As illustrated, first part 26 of coupler system 10 is generally hollow having an interior space 54, and has an external surface with a frustoconical portion 50 at the conical first end 28 of first part 26 and a cylindrical portion 52 at the opposing second end 29 of first part 26. Wedge-shaped groove 30 extends longitudinally along external surface. Cylindrical portion 52 of first part 26 also includes a plurality of ridges 56 that are evenly spaced apart, extend longitudinally and are parallel to the axis of the first part 26. These ridges can increase the friction between first part 26 and second part 32 so as to improve the security of the connection when the coupler system is assembled. Additionally, the ridges 56 can assist in aligning the wedge-shaped groove 30 over the bulge 40 as first part 26 and second part 32 are brought together. Alternatively, cylindrical portion 52 can be smooth, that is, having no ridges.

FIGS. 7-10 show the second part 32 of the coupler system 10 in greater detail. As illustrated, second part 32 is generally tubular in shape having an interior space or hollow center 60, and includes a receiving end 62 and an opposing second end 64. Receiving end 62 is dimensioned to receive conical first end 28 of first part 26, and opposing second end 64 includes bulge 40 that compliments wedge-shaped groove 30 of first part 26. Additionally, second part 32 includes a cylindrical slot 70, which is formed between inner and outer cylinders 36, 34, dimensioned to receive second segment 25. Preferably, inner cylinder 36 extends beyond the length of outer cylinder 34 at second end 64 so as to facilitate engagement with tubular tree trunk segments. The interior surface of second part 32 also includes a plurality of guide members 66 that extend longitudinally and parallel to the axis of the second part 32. These guide members 66 can assist positioning the plurality of ridges 56 of the first part 26 so that enhanced alignment and securing is provided with first part 26 is inserted into second part 32. Alternatively, the interior surface of second part can be smooth, that is, having no guide members.

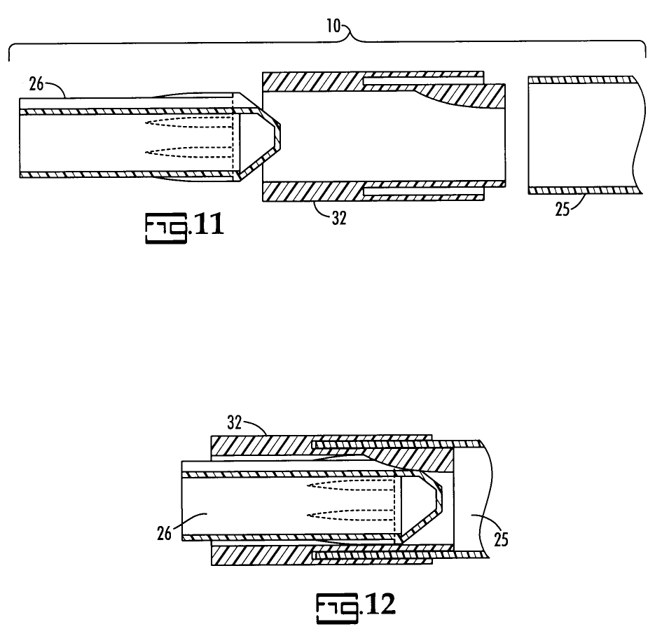

The coaxial nesting and key fit relationship between first part 26, second part 32, and at least one tubular segment of an artificial tree is shown in FIGS. 11-12. As illustrated, coupler system 10 is assembled by sliding conical first end 28 of first part 26 into second part 32, which aligns and secures first part 26 by frictionally engaging the wedge-shaped groove 30 with the complementary bulge 40. In use, the tubular segments forming the trunk of an artificial tree, such as first and second tubular segments 24, 25, are connected by inserting opposing end 29 of first part 26 into first tubular segment 24 (not shown), and by inserting second tubular segment 25 into the slot 70 of second part 32.

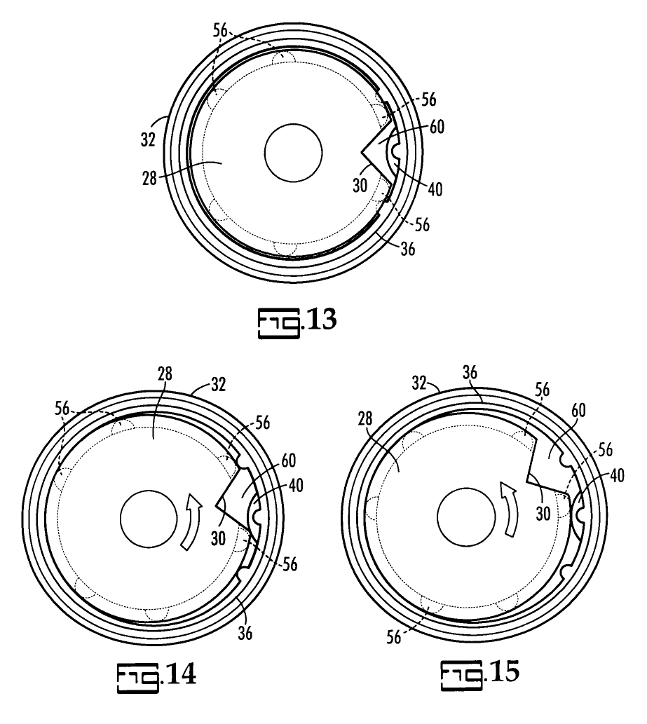

When assembling the tree coupler system 10, certain optional features assist in aligning and securing the first and second parts 26, 32. As illustrated in FIGS. 13-15, in addition to the key fit relationship between the wedge-shaped groove 30 and the corresponding bulge 40, first part includes plural ridges 56, with at least one ridge on either side of the wedge-shaped groove 30. Additionally, the second part includes plural guide members 66, with at least one guide member on either side of the bulge 40. As first part 26 becomes inserted into second part 32, the guide members 66 align the wedge-shaped groove 30 to receive the bulge 40 by engaging and surrounding the ridges 56 included on either side of the groove 30. Additionally, the ridges 56 and guide members 66 can help to prevent the first part 26 from twisting out of place when it is inserted into second part 32.

As discussed, preferably first and second parts 26, 32 are made of plastic. The use of plastic rather than metal avoids corrosion of the parts. Accordingly, the shape and proper fitting of parts is maintained. More importantly, the parts are much easier to separate when they remain free of the negative effects of oxidation. Corroded tree segments and couplers of assembled trees must often be forced apart. Furthermore, as many artificial trees include the use of light strings, which are delicate in nature, damage to these light strings is minimized or avoided when the tree segments can be more easily separated.

The foregoing description of preferred embodiments of the invention has been presented for purposes of illustration and description. It is not intended to be exhaustive or to limit the invention to the precise form disclosed, and obviously many modifications and variations are possible in light of the above teachings. The embodiments were chose and described in order to best explain the principles of the invention and its practical application to thereby enable one skilled in the art to best utilize the invention in various embodiments and with various modifications as are suited to the particular use contemplated. It is intended that the scope of the invention be defined by the claims appended hereto.

What is claimed is:

1. A tree coupler system, comprising:
a first part having a first end and an opposing second end and carrying a wedge-shaped groove parallel to its axis, wherein said second end is dimensioned to be nested within a first tubular segment that forms a first portion of a tree trunk; and
a second part including an outer cylinder connected to an inner cylinder, wherein a slot is formed between said inner cylinder and said outer cylinder, wherein said first part is insertable into said second part, wherein said inner cylinder includes a bulge parallel to its axis that aligns with said wedge-shaped groove of said first part, and wherein said slot is dimensioned to receive a second tubular segment that forms a second portion of a tree trunk.

2. The system as recited in claim 1, wherein said first part has an external surface with a frustoconical portion at said first end and a cylindrical portion at said second end.

3. The system as recited in claim 1, wherein said second part includes a receiving end and an opposing end, wherein the length of said inner cylinder extends beyond the length of said outer cylinder at said opposing end.

4. The system as recited in claim 3, wherein said receiving end is dimensioned to receive said first end of said first part, and wherein said bulge is at said opposing end.

5. The system as recited in claim 1, wherein said first and second tubular segments are connected to a top portion and a bottom portion of an artificial tree, respectively.

6. The system as recited in claim 1, wherein said first part carries a plurality of ridges parallel to its axis.

7. The system as recited in claim 6, wherein said plurality of ridges includes at least one ridge on either side of said wedge-shaped groove.

8. The system as recited in claim 6, wherein said plurality of ridges are spaced apart evenly.

9. The system as recited in claim 7, wherein said inner cylinder carries a plurality of guide members.

10. The system as recited in claim 7, wherein said plurality of guide members, includes at least one guide member on either side of said bulge.

11. The system as recited in claim 10, wherein said at least one guide member engages said at least one ridge on either side of said wedge-shaped groove when said first part is nested within said second part.

12. The system as recited in claim 1, wherein said first part and said second part are made of plastic.
